(19) United States
(12) Patent Application Publication
(10) Pub. No.: US 2006/0260856 A1
(43) Pub. Date: Nov. 23, 2006

(54) Sportsman's kart

(76) Inventor: Gladys Houlder, Keamey, MO (US)

Correspondence Address: LAMBERT & ASSOCIATES, P.L.L.C., 92 STATE STREET, BOSTON, MA, 02109-2004, US

(21) Appl. No.: 11/131,514

(22) Filed: May 18, 2005

(51) Int. Cl. B62D 31/00; B60R 7/00

(52) U.S. Cl. 180/89.1; 296/37.1; 180/190; 180/65.1

(57) ABSTRACT

The sportsman's kart of the present invention comprises a powered vehicle capable of carrying at least one operator and a variety of sports gear and other items. The sportsman's kart may be adapted to carry sports articles such as fishing rods, baseball bats, and a variety of racquets and sports sticks. The sportsman's kart may also include storage receptacles for storing additional items, which may or may not be sport related. The storage receptacles may be permanently attached to the frame, or may be removably attached, as desired. The sportsman's kart may be utilized for hunting, fishing, baseball, lacrosse, tennis, golf, or any other recreational activity.

### BACKGROUND

1. Field of the Invention

The present invention relates generally to the field of sports equipment storage and transportation, and more particularly to a powered sports equipment transport vehicle.

2. Description of Related Art

Almost every sport or leisure activity requires the use of special equipment. Baseball requires bats, balls and gloves; lacrosse requires sticks, balls, gloves, helmets and pads; fishing requires poles, tackle, and line; hunting requires guns, ammunition, bows, and safety gear. These are of course oversimplifications of the necessary equipment requirements, and are listed to illustrate the fact that for even the most rudimentary endeavors, a great quantity of gear may be required.

The requirement for a large amount of gear and equipment naturally creates the problem of storing and transporting the gear. It is infrequently the case that the gear is stored at the location where it will be used. Therefore, the equipment must be transported from its storage location, to the location where it will be used.

By way of example, and not limitation, a typical fishing excursion will be considered. The person involved will require various articles of clothing and protective gear. Waders, hats, vests, boots, extra socks, pants, shirts and jackets are but a few of the items necessary to properly clothe the person interested in fishing. Gear can include poles, reels, buckets used to transport caught fish, leaders, hooks, live bait, artificial bait, sinkers and weights, scissors and clippers, lanyards, knifes, nets, rulers, flies, lures, and assorted other tackle. Of course various equipment will be desired that is of personal importance and not related to the activity being undertaken. It is evident then, that simply gathering this equipment and getting it to the fishing site can be quite an endeavor.

One solution in the fishing example is to load up a car, and make several trips to the actual fishing site. Carrying the gear in multiple trips includes numerous disadvantages. If the fishing site is any distance from where vehicles must park, as it often is, the trips can be very laborious. In addition, expensive rods and other equipment may be left unattended at the fishing site during trips to and from the automobile. Also, the average person will attempt to carry as much equipment as possible in order to limit the number of trips required. The result being an over-burdened individual, most likely with impaired visibility and dexterity, trudging through the woods or down steep banks.

Some solutions have been offered in response to the fishing gear burden. U.S. Design Patent No. 411,360 discloses the ornamental design for a cart designed to transport fishing gear. The design appears similar to a collapsible golf pull-cart, modified to accommodate fishing gear.

U.S. Pat. No. 5,611,561 discloses a collapsible fishing cart that is designed to hold a plurality of rods and other gear. The cart is designed to be pulled by the individual to and from the fishing site.

U.S. Pat. No. 6,082,757 discloses another collapsible fishing cart that includes rod holders and space to store boxes and the like.

One disadvantage of the aforementioned devices is that they can realistically only hold fishing gear. Further, if the route to the fishing site includes any muddy areas, the prior art carts will likely become stuck, and are prone to tipping over. In addition, the prior art carts do not contemplate rough terrain, such as rocks and roots, which are both typical features adjacent to most fishing environments. Also, any amount of snow or ice on the ground will render the prior art carts virtually useless.

Moving away from the fishing example, other carts exist that may be employed in the storage and transportation of other sporting equipment and associated gear. For example a golf pull cart is useful in carrying a bag of golf clubs. Motorized golf carts may carry the golf club bag, along with the individuals, and typically provide a basket for additional gear. These other types of carts provide sufficient transportation services for their intended purpose, yet the carts are limited in the types of gear they can carry, and the environment in which they can operate.

Therefore, what is required is a sportsman's kart that can carry a variety of types of sports equipment, accessories and personal gear for hunting, fishing, every sport and common use groceries, laundry and gardening.

What is also required is a sportsman's kart that can operate in different terrains and environments.

It is also required to provide a sportsman's kart that can carry the necessary equipment to the desired location, in addition to carrying one or more individuals.

### BRIEF SUMMARY OF THE INVENTION

Accordingly, it is an object of the present invention to provide a sportsman's kart that can carry and store a variety of types sports equipment, related gear and personal items.

It is a further object of the present invention to provide a sportsman's kart that can operate on all types of terrain, in any kind of weather or environment.

It is also an object of the present invention to provide a sportsman's kart that can carry equipment along with at least one individual.

### BRIEF DESCRIPTION OF THE SEVERAL VIEWS OF THE DRAWINGS

FIG. 1 is a perspective view of the sportsman's kart of the present invention.

FIG. 2 is a top view of the sportsman's kart of the present invention.

FIG. 3 is a side view of the sportsman's kart of the present invention.

FIG. 4 is a back view of the sportsman's kart of the present invention.

FIG. 5 is a side view of an embodiment of the sportsman's kart of the present invention equipped for travel over snow and/or ice.

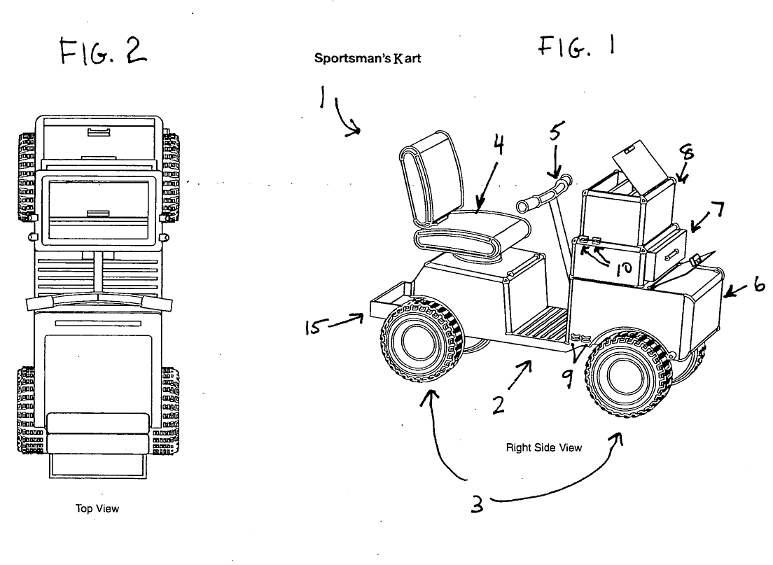

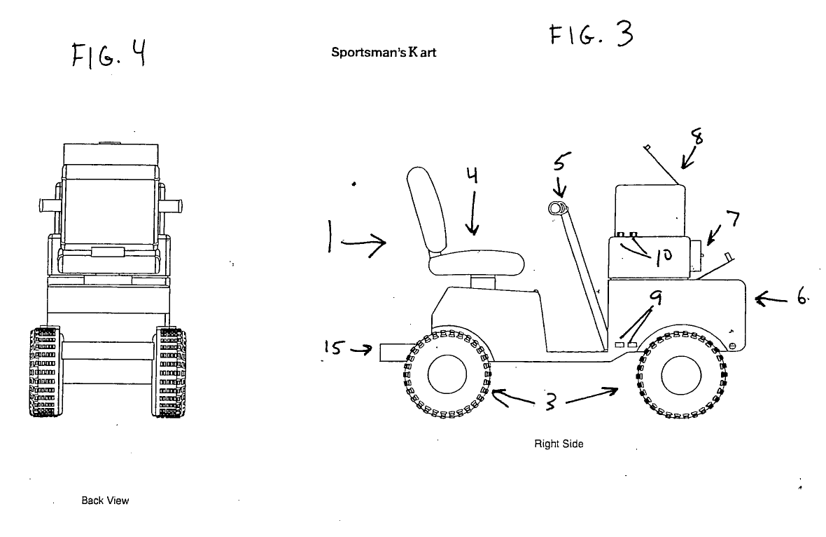

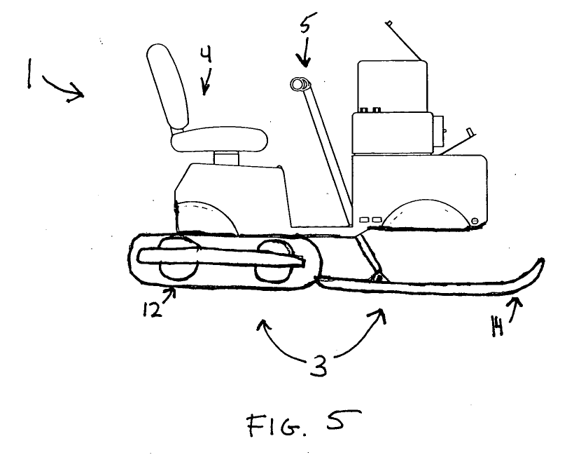

### DETAILED DESCRIPTION OF THE INVENTION

The sportsman's kart 1 of the present invention is seen in a perspective view in FIG. 1. Frame 2 is depicted supporting first storage receptacle 6, upon which second storage receptacle 7 and third storage receptacle 8 are attached. Propulsion supports 3 are shown as wheels in the preferred embodiment illustrated in FIG. 1. Steering member 5 is shown as a form of handle bars in the preferred embodiment, located a suitable distance from operator support 4 to provide easy control of sportsman's kart 1.

The frame 2 should be strong enough to support an operator as well as the desired equipment, and may be constructed of steel and other materials, or a combination of materials as is known in the art. Operator support 4 preferably includes a back support, and allows the user to swivel in either direction. Steering member 5 may be in the form of a handle bar type, steering wheel, or any suitable steering means as is known in the art. Propulsion supports 3 are shown as a set of four wheels connected to a means for propelling the sportsman's kart 1, said means for propelling (not shown) being preferably located under the frame, as is well known within the art. The means for propelling may comprise an internal combustion engine, electric motor with or without rechargeable batteries, a hybrid engine, or other means for propelling, as is well known in the art. Additionally, it will be apparent to those skilled in the art that the means for propelling may be easily linked to the propulsion supports (via drive shafts or the like) to translate the necessary energies into movement.

Where the propulsion supports 3 comprise wheels, these are preferably similar to those of other all-terrain vehicles; being of suitable strength to withstand punctures and other stresses commonly experienced in outdoor travel. The wheels should also be capable of supporting the weight of the sportsman's kart 1 and its attendant load.

A first storage receptacle 6 may be removably attached to the sportsman's kart 1. The first storage receptacle 6 may be thermally insulated, watertight, and may also contain a first storage receptacle drain. In one embodiment, first storage receptacle 6 may be used as a livewell for the storage of bait, or as a cooler for storing food, beverages, or anything else that needs to be in a temperature controlled environment.

Preferably, second storage receptacle 7 is removably attached to first storage receptacle 6. Second storage receptacle 7 is preferably a drawer-type receptacle. Third storage type receptacle 8 may be removably attachable to second storage receptacle 7. Third storage receptacle 8 preferably includes a flip open lid, removable shelves, and a number of individual compartments. The individual compartments may be easily altered in size via dividers within the third storage receptacle 8, as is well known in the art. Third storage receptacle 8 is preferably ideal for storing smaller items, such as fishing tackle and the like, or any small items as desired. Additionally, the storage receptacle 8 may allow for the insertion of different size baskets for holding items of varying sizes. Further, a platform 15 with raised sidewalls may be included on the rear of the sportsman's kart 1 to hold and secure baskets of varying sizes, or any other articles that may be placed within.

The outer sidewalls of first storage receptacle 6, second storage receptacle 7, third storage receptacle 8 and/or the frame 2 of sportsman's kart 1 may include sport article retainers 11, indicated in FIG. 1 by the combination of lower receiving portions 9, and upper securing portions 10. The sport article retainer 11 is preferably adapted to provide for the storage and transport of sport articles that include an elongated portion. An example of an elongated portion may be a sport shaft. The sport article retainer 11 may include a lower receiving portion 9 that comprises a substantially horizontal shelf. The substantially horizontal shelf may be substantially flat, or include an indented portion with or without sidewalls. The lower receiving portion 9 may also include a drain area, comprising either a hole or other opening sufficiently sized to allow the removal of water and/or debris.

The sport article retainer 11 preferably also includes an upper securing portion 10. The upper securing portion 10 may comprise a clip portion, or other means suitable for securing an elongated portion of a sport article, such as a shaft. The term “sport article” is meant to encompass all sports related equipment, in its broadest sense, and also non-sports related equipment. In an embodiment where the upper securing portion 10 comprises a clip, it should be understood that a clip may be defined as including moving or non-moving portions, resilient or non-resilient portions, and flexible or non-flexible portions. The clip, as used in this application includes the standard definition of a clip, but also includes the various embodiments noted herein and any modifications necessary to secure a portion of a sport article. In one embodiment, the clip may comprise an outer portion and an inner portion that comprises a resilient, flexible area, made from material such as foam, or any material that includes substantially the characteristics of foam. The foam portion may be glued or similarly attached to the outer portion such that a narrow channel is formed in a substantially central portion of the upper securing portion 10. This narrow channel will then impart sufficient frictional forces upon the shaft so as to prevent dislodgement during movement of the sportsman's kart.

Other embodiments of the clip may include a pair of posts operated in conjunction with a resilient fastening member. In practice, the resilient fastening member may be a form of elastic band, made of material suitable to withstand the elements and the rigors of attachment and detachment. Material used in the well-known “bungee cord” could be considered as an exampled of material suitable in this embodiment. By placing the shaft portion between the two posts, the elastic band may be stretched between the posts and over, and/or around, the shaft, thereby securing the shaft to the sportsman's kart 1. Other variations of the upper securing portion may include latch-style clips, spring clips, or any suitable configuration that will retain the sport article in a secure fashion.

Fishing, hunting, lacrosse, baseball, basketball, and almost any conceivable recreational or non-recreational activity can benefit from the use of the sportsman's kart 1. For illustrative purposes, the sport article transported and/or stored in sport article retainer 11 may be a fishing rod. The fishing rod handle may be placed, or set upon, the lower receiving portion 9, and the upper end of the rod may be pressed into the upper securing portion 10. In the embodiment where the clip includes a foam-like material, the narrow channel within the foam portion is preferably smaller in width than the diameter of the fishing rod, thereby creating the frictional forces necessary to retain the rod for storage and transportation.

In another example of a preferred embodiment, the sport article may be a lacrosse stick. The handle of the lacrosse stick would be placed in or on the lower receiving portion 9 and the upper end would be secured to the desired clip configuration utilized in a preferred embodiment. In addition, the present invention may include clips of different sizes to ft guns, golf clubs, bats, hockey sticks, etc.

It will be clear to those skilled in the art that other outdoor activities will enjoy a number of the benefits provided by sportsman's kart 1. In addition to fishing, hunters and outdoor enthusiasts will find that the sportsman's kart 1 allows them to access the areas that interest them in almost any kind of weather or terrain.

In further detail, the sport article retainer 11 may be permanently affixed to a portion of the sportsman's kart. In a preferred embodiment the sport article retainer 11 may be removably affixed to a portion of the sportsman's kart. Where the sport article retainer 11 comprises a removable embodiment, various configurations of the upper securing portion 10 may be employed as is required by the form of sport article desired to be secured. More plainly, where the sport article comprises a fishing rod, it may be desirous to employ an upper securing portion 10 that comprises the foam securing embodiment. Where a lacrosse shaft is used, a simple frictional or other clip device may be desired. The sport article may comprise any type of sport item, and the sport article retainer 11 may include either the upper securing portion 10, or lower securing portion alone 9, or both portions working together. The sport article retainer 11 may be removably attachable to the sportsman's kart frame, or to any of the sportsman's kart 1 accompanying accessories, such as the first, second or third storage receptacles.

In another embodiment, as depicted in FIG. 5, propulsion supports 3 may comprise instrumentalities suitable for transporting the sportsman's kart 1 and associated load in severe environmental conditions such as snow and ice. In this embodiment, all aspects of the sportsman's kart 1 remain essentially unchanged, with the exception of propulsion supports 3. Propulsion supports 3 may further comprise a drive track portion 12, such as a track suitable for travel over ice and snow, and at least one ski portion 14, suitable for steering and controlling the sportsman's kart 1. It is possible for ski portion 14 to include a pair of skis as is known in the art. Further, propulsion supports 3 may be easily converted from wheels to drive track portion 12 and ski portion 14 as is known in the art. This embodiment converts the sportsman's kart 1 into a vehicle that may be used in snow sports, such as skiing, snowboarding, and ice fishing, to name a few examples. Additionally, slight modifications such as six wheels, or dual tracks are well within the scope of modifications to propulsion supports 3 contemplated by the present invention.

Although the present invention has been described with reference to particular embodiments, it will be apparent to those skilled in the art that variations and modifications can be substituted therefore without departing from the principles and spirit of the invention.

What is claimed is:

1. A sportsman's kart comprising:
a frame;
a means for propelling the sportsman's kart, said means for propelling attached to said frame;
an operator support attached to said frame;
a steering member for directing said sportsman's kart;
a plurality of propulsion supports for supporting the sportsman's kart;
a sport article retainer attached to the sportsman's kart; and
a first storage receptacle attached to said frame.

2. The sportsman's kart of claim 1, wherein said sport article retainer further comprises a lower receiving portion.

3. The sportsman's kart of claim 2, wherein said sport article retainer further comprises an upper securing portion.

4. The sportsman's kart of claim 3, wherein said lower receiving portion comprises a substantially horizontal platform.

5. The sportsman's kart of claim 4, wherein said upper securing portion comprises a securing clip.

6. The sportsman's kart of claim 5, wherein said lower receiving portion further comprises sidewalls and a drain area.

7. The sportsman's kart of claim 6, wherein said securing clip comprises an outer portion, and wherein said securing clip comprises an inner portion.

8. The sportsman's kart of claim 6, further comprising a first storage receptacle.

9. The sportsman's kart of claim 7, wherein said inner portion comprises a foam material.

10. The sportsman's kart of claim 8, wherein said first storage receptacle further comprises an insulated interior.

11. The sportsman's kart of claim 10, wherein said first storage receptacle further comprises a watertight portion.

12. The sportsman's kart of claim 10, further comprising a second storage receptacle.

13. The sportsman's kart of claim 10, wherein said first storage receptacle is removably attachable.

14. The sportsman's kart of claim 10, wherein said second storage receptacle further comprises interior drawers.

15. The sportsman's kart of claim 12, wherein said second storage receptacle is removably attachable.

16. The sportsman's kart of claim 13, wherein said means for propelling the sportsman's kart comprises electric propulsion.

17. The sportsman's kart of claim 13, wherein said means for propelling the sportsman's kart comprises fuel driven propulsion.

18. The sportsman's kart of claim 13, wherein said means for propelling the sportsman's kart comprises a hybrid propulsion.

19. The sportsman's kart of claim 14, wherein said means for propelling further comprises a rechargeable battery.

20. The sportsman's kart of claim 14, wherein said propulsion supports comprise wheels.

21. The sportsman's kart of claim 14, wherein said propulsion supports comprises a drive track portion and at least one ski portion.

22. A sportsman's kart comprising:
a frame;
a means for propelling the sportsman's kart, said means for propelling attached to said frame;
an operator support attached to said frame;
a propulsion support supporting said frame;
a steering member for controlling the direction of said sportsman's kart;
a sport article retainer attached to said sportsman's kart;
a first storage receptacle attached to said frame; and
a second storage receptacle attached to said first storage receptacle.

23. The sportsman's kart of claim 22, wherein said first storage receptacle further comprises a substantially watertight receptacle.

24. The sportsman's kart of claim 23, wherein said first storage receptacle further comprises a drain port.

25. The sportsman's kart of claim 24, further comprising a third storage receptacle, wherein said third storage receptacle is attached to said second storage receptacle.

26. The sportsman's kart of claim 25, wherein said first storage receptacle, said second storage receptacle, and said third storage receptacle are removably attachable.

27. The sportsman's kart of claim 26, wherein said propulsion support comprises wheels.

28. The sportsman's kart of claim 27, wherein said propulsion support comprises a drive track portion and at least one ski portion.
